(19) United States
(12) Patent Application Publication
(10) Pub. No.: US 2004/0033856 A1
(43) Pub. Date: Feb. 19, 2004

(54) Seamable pinspotter belt

(76) Inventor: Mark J. Levine, Hendersonville, TN (US)

Correspondence Address: FROMMER LAWRENCE & HAUG, 745 FIFTH AVENUE- 10TH FL., NEW YORK, NY, 10151, US

(21) Appl. No.: 10/218,836

(22) Filed: Aug. 14, 2002

(51) Int. Cl. F16G 1/00; F16G 5/16

(52) U.S. Cl. 474/247; 474/239; 474/237

(57) ABSTRACT

An on-machine-seamable industrial belt comprising a coated spiral base with a pin seam that offers easy installation, durability, high surface friction, and strength. The belt construction includes a helical spiral base produced from primarily polyester monofilament or blends thereof. The coating material is a liquid silicone rubber elastomer of Shore A durometer 15-50. The coating penetration encapsulates at least the top spiral filament and extends beyond the top surface of the base. The seam strength is substantially equal to that of the fabric body.

### BACKGROUND OF THE INVENTION

1. Field of the Invention

The present invention relates primarily to industrial belts. More specifically, the present invention relates to seamable belts for use in conveying, in addition to other industrial applications.

2. Description of the Prior Art

There are many applications for seamable industrial belts in which the idea of having a seam was heretofore not possible.

One such application is as a carpet belt in a bowling alley pinspotter machine, such as the AMF 90XL type pinspotter, in which a large belt is used to catch and convey the ball and pins to the ball return and pin distribution system respectively. To date, this belt has typically been of synthetic rubber coated endless construction, and has required 2-3 hours for removal and replacement due to machine design and the extremely small workspace available for the technician to maneuver.

Past attempts to supply an on-machine-seamable belt have met with failure due to a lack of durability and ultimately tensile strength. In the case of pinspotter belts, continual impact damage due to a 9-16 pound ball hitting the belt at high speed has led to seam failure. Metal clipper type seams were tried in the past, but failed due to the ball impact jarring loose the seam. In this connection, there is a heavy, solid, non-compressible bounce board underneath the belt that provides for no absorption of the ball impact with a metal seam.

### SUMMARY OF THE INVENTION

The present invention is a coated spiral belt having, for example, a pinable seam that provides for easy installation, durability, high friction surface and strength. Such a belt also absorbs ball impact well. Further, the belt can be installed quickly. For example a carpet belt for a pinspotter machine can typically be installed in less than thirty minutes. Further, the seam strength of such a belt is substantially equivalent to that of the fabric body.

Finally, the belt will be particularly useful for other applications where the belt cost is a low cost component of the application, but where the downtime and labor effort to install the belt is high.

### BRIEF DESCRIPTION OF THE DRAWINGS

FIG. 1 depicts a prior art carpet belt;

FIG. 2 is a plan view of a section of the helical spiral base for the industrial belt of the present invention;

FIG. 3 is a schematic side elevation view showing the construction of the industrial belt of the present invention; and

FIG. 4(a) and FIG. 4(b) illustrate two aspects of splicing and seam formation.

### DETAILED DESCRIPTION OF THE PREFERRED EMBODIMENT

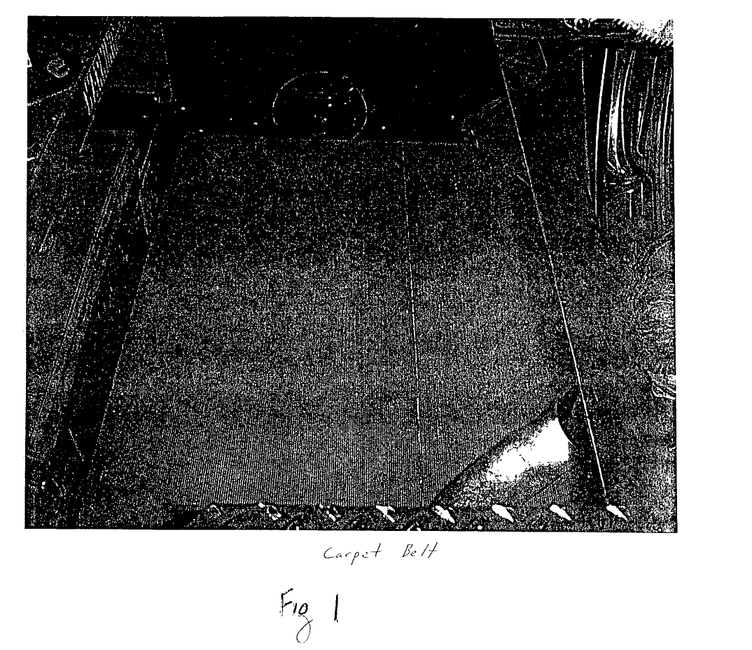

FIG. 1 shows a prior art carpet belt used in an AMF 90XL type pinspotter machine.

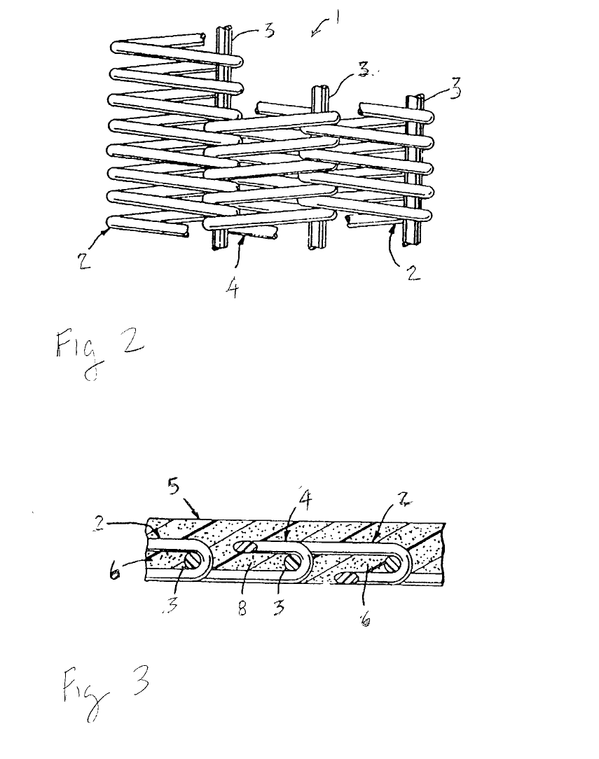

FIG. 2 illustrates a portion of a spiral base 1 which forms part of the industrial belt according to the present invention.

Spiral base 1 is constituted of oppositely oriented axially extending spirals 2, 4. Spirals 2 are oriented in one direction, e.g. with their upper portions being inclined leftwardly, while spirals 4 are oriented oppositely, e.g. with their upper portions inclined to the right between spirals 2.

Spirals 2 and 4 extend along parallel longitudinal axes. Referring to FIG. 3, spirals 2 and 4 define longitudinally extending internal passages 6, 8, respectively. Spirals 2 and 4 are arranged to overlap each other, so that the end portions of internal spaces 6, 8 overlap. Pintles 3 extend through the overlapping portions of spiral internal spaces 6, 8, to connect spirals 2 and 4 into a continuous material.

A coating 5 is applied to the spiral base 1. The coating penetration encapsulates at least the top of the spiral filament and extends beyond the top surface 0.010-0.250 inches or more. Accordingly, the belt may be made relatively thick since the coating can extend, for example, a quarter inch above the base spirals. In fact, there are not practical limits on coating thickness—up to 0.500 inches coatings could be used, although this limitation is more convenience related. It is preferable that the belt is kept relatively thin and flexible providing easier maneuverability when it is removed by a technician working in the small workplace for example, as defined by the pinspotter machine.

The helical spiral base of the belt may be produced from, for example, primarily polyester monofilaments or blends thereof. While polyester and polyamide are most common, other polymers can be used if certain properties are desired. Metal can also be used to form the spirals. Also while the starting monofilament which forms the spiral can be round in cross section, other shapes can be utilized, and a variety of other spiral materials, dimensions and filament shapes may be utilized.

Ideally, the material used to coat the spiral base should have high elasticity/impact resistance and adequate adhesion of the coating to the spirals. In a preferred embodiment, the coating material is a liquid silicone rubber elastomer of Shore A durometer 15-50. The 30-50 durometer silicone elastomers have a good balance of elasticity, tear strength, and crystalline induced stress upon curing. Because of this, mechanical encapsulation of at least the top strand in the spiral is good enough to prevent delamination of the surface coating.

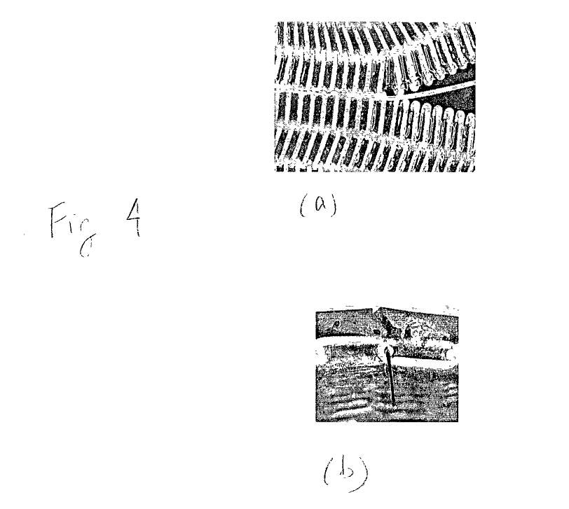

The aforementioned induced stress in the coating and its relatively low adhesion to the spirals is important for splicing and seam formation. Referring to FIGS. 4. (a) and (b), when a surface cut is made above the spiral link over the pintle or pin seam, the stress in the coating material causes it to “spring back” and clear away from the spiral loops. Additionally, the coating's relatively low adhesion to the spirals allows it to be easily cleaned off the latter. This all results in a clean seam with minimal labor.

It should be noted that while a silicone rubber coating is referred to, other types of polymers suitable for the purpose may be utilized. In addition, while a coating has been referred to, the polymer can impregnate the entire structure if so desired and depending upon the application.

Furthermore, the manner of coating can vary so as to protect the seam area from being filled with the coating which would obstruct the placement of a pintle or pin therein, as will be readily apparent to one skilled in the art.

In addition while a pin seam has been referred to and is well known to those skilled in the art, other seaming method suitable for the purpose may be utilized depending upon the application.

Modifications to the above would be obvious to those of ordinary skill in the art, but would not bring the invention so modified beyond the scope of the appended claims.

What is claimed is:

1. An on-machine-seamable industrial belt comprising:
a helical spiral base, said base defining a top surface and a bottom surface and including a plurality of side-by-side spirals, each spiral defining an internal space, wherein the spirals are interconnected by a series of parallel pintles extending through the internal spaces of adjacent spirals; and
a coating applied to said base, the coating encapsulating at least the top of the spiral filament, and extending at least past the top surface of the base.

2. The belt of claim 1, wherein the coating fills the internal spaces of the spirals.

3. The belt of claim 1, wherein said coating is a liquid silicone rubber elastomer of Shore A durometer 15-50.

4. The belt of claim 1, wherein the coating extends between 0.010 and 0.250 inches beyond the top surface of the spiral base.

5. The belt of claim 1, wherein the spirals forming the base are produced from either synthetic polymers or metal.

6. The belt of claim 1, wherein the spiral base is produced from primarily polyester monofilament.

7. A carpet belt for use in a pinspotter machine, said carpet belt comprising:
a helical spiral base, said base defining a top surface and a bottom surface and including a plurality of side-by-side spirals, each spiral defining an internal space, wherein the spirals are interconnected by a series of parallel pintles extending through the internal spaces of adjacent spirals; and
a coating applied to said base, the coating coating encapsulating at least the top of the spiral filament, and extending at least past the top surface of the base.

8. The belt of claim 7, wherein said coating is a liquid silicone rubber elastomer of Shore A durometer 15-50.

9. The belt of claim 7, wherein the coating extends between 0.010 and 0.250 inches beyond the top surface of the spiral base.

10. The belt of claim 7, wherein the spirals forming the base are produced from either synthetic polymers or metal.

11. The belt of claim 5, wherein the spiral base is produced from primarily polyester monofilament.

12. The belt of claim 7, wherein the coating fills the internal spaces of the spirals.
